(19) United States
(12) Patent Application Publication
(10) Pub. No.: US 2009/0089711 A1
(43) Pub. Date: Apr. 2, 2009

(54) SYSTEM, APPARATUS AND METHOD FOR A THEME AND META-DATA BASED MEDIA PLAYER

(76) Inventors: Randy R. Dunton, Phoenix, AZ (US); C. Brendan S. Traw, Portland, OR (US)

Correspondence Address: Molly A. McCall;Intel Corporation, c/o Intellevate, LLC, P. O. Box 52050, Minneapolis, MN, 55402, US

(21) Appl. No.: 11/864,586

(22) Filed: Sep. 28, 2007

(51) Int. Cl. G06F 3/048

(52) U.S. Cl. 715/838

(57) ABSTRACT

A system, apparatus and method for a theme and meta-data based media player is presented. A method includes determining meta-data associated with a plurality of photographs. One or more tags are then determined that are associated with the meta-data, where the one or more tags indicate a frequency and a number of the meta-data. A starting point for a presentation of photographs from a user is accepted. Then, based on the starting point, the one or more tags and a rule set, a list of photographs is automatically generated from the plurality of photographs to be included in the presentation. Other embodiments are described and claimed.

### BACKGROUND

The introduction of digital content into today's homes creates new challenges and opportunities for content providers and consumers. For example, today's homes may have one or more electronic devices that process and/or store content, such as personal computers (PCs), televisions, digital video disk (DVD) players, video cassette recorder (VCR) players, compact disk (CD) players, set-top boxes, stereo receivers, audio/video receivers (AVRs), media centers, personal video recorders (PVRs), gaming devices, digital camcorders, digital cameras, cell phones, and so forth. These all may be networked together in such a way to provide a user with a means for entertainment via the home entertainment center and a single display device.

The networked digital home environment provides a user with many options to choose from when the user is searching for available media content. For example, a typical family may have thousands of photographs stored on one or more of the electronic devices in the digital home network and on one or more electronic devices not in the digital home network. As the number or photographs keeps increasing, many people simply do not have the time or desire to organize or annotate their photographs. The navigation and manipulation of this many photographs are slow and confusing. It is difficult and time consuming to create, for example, a slideshow of desired photographs.

### BRIEF DESCRIPTION OF THE DRAWINGS

FIG. 1 illustrates one embodiment of an environment.

FIG. 2 illustrates one embodiment of a logic flow.

FIG. 3 illustrates one embodiment of a media processing system.

FIG. 4 illustrates one embodiment of a logic flow.

### DETAILED DESCRIPTION

Various embodiments may be directed to a system, apparatus and method for a theme and meta-data based media player. Embodiments include a means to analyze media (such as photographs or video clips) and automatically create, with very little interaction from a user, a meaningful presentation of the photographs for the user. One possible type of presentation may include a slideshow-style presentation or “slideshow”. Embodiments provide for user feedback on the selection of photographs in the automatically-generated slideshows in order to customize slideshows generated by the invention in the future. Other embodiments are described and claimed.

Various embodiments may comprise one or more elements or components. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

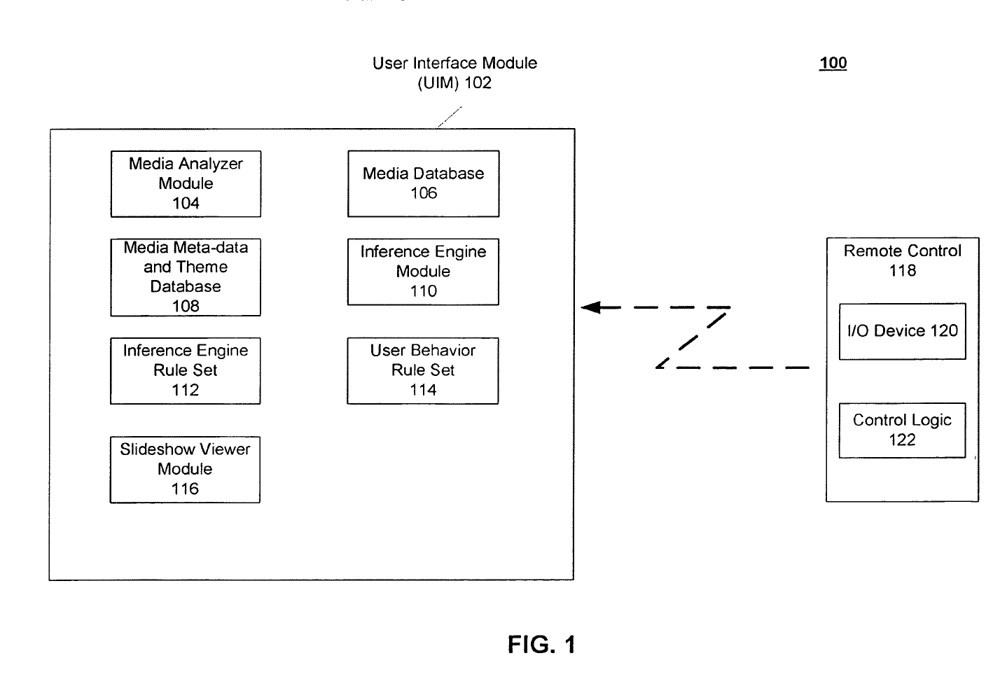

FIG. 1 illustrates one embodiment of an environment in which embodiments of the invention may operate. Referring to FIG. 1, the environment may include a media player or user interface module (UIM) 102 and a remote control 118. UIM 102 may include a media analyzer module 104, a media database 106, a media meta-data and theme database 108, an inference engine module 110, an inference engine rule set 112, a user behavior rule set 114 and a media slideshow viewer module 116. All of the components of UIM 102 may include the appropriate interfaces (e.g., API) to communicate information with UIM 102. Note that although the functionality of UIM 102 is described herein as being separated into seven components or elements, this is not meant to limit the invention. In fact, this functionality may be accomplished via any number of components or elements.

Remote control 118 may include an input/output (I/O) device 120 and control logic 122. Each of the elements or components illustrated in FIG. 1 is described next in more detail.

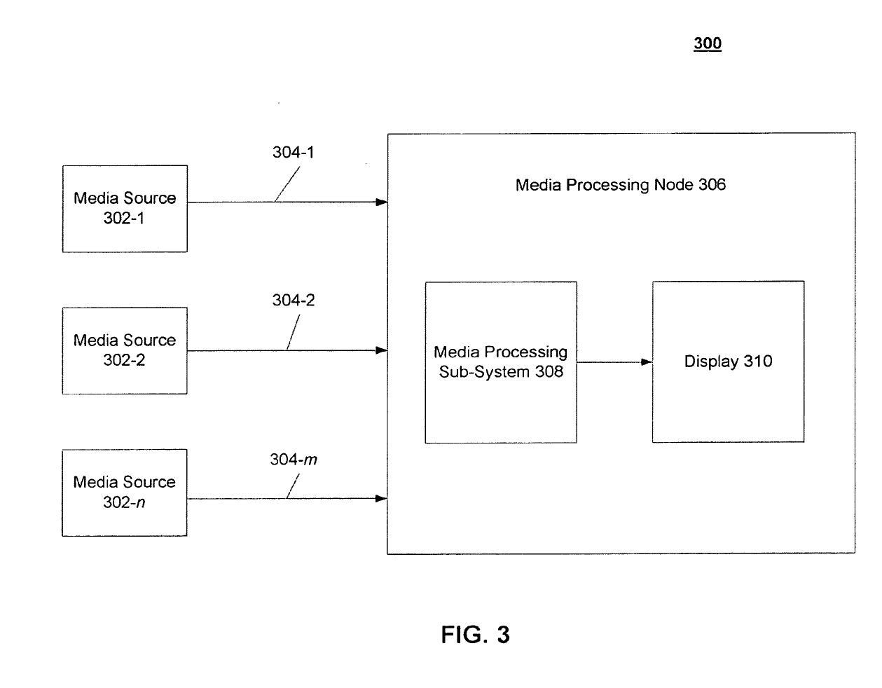

In one embodiment, for example, a media processing sub-system may include various application programs, such as UIM 102. For example, UIM 102 may comprise a GUI to communicate information between a user and the media processing sub-system. Although embodiments of the invention may be described herein with reference to a networked digital home environment, this is not meant to limit the invention and is provided for illustration purposes only. An example media processing sub-system will be described in detail below with reference to FIG. 3.

UIM 102 may be used to analyze media (such as photographs) and automatically create, with very little interaction from a user, a meaningful presentation of the photographs for the user. One possible type of presentation may include a slideshow-style presentation or “slideshow”. Embodiments provide for user feedback on the selection of photographs in the automatically-generated slideshows in order to customize slideshows generated by the invention in the future. Although embodiments of the invention may be described herein with reference to photographs, the invention applies to any media content or information including, but are not limited to, alphanumeric text, symbols, images, graphics, audio, video clips, and so forth.

Referring to FIG. 1, media analyzer module 104 analyzes all available photographs for meta-data. In embodiments, photographs may be stored in media database 106 or on one or more electronic devices in the digital home network.

In embodiments, well known object recognition techniques (i.e., machine learning) are used to recognize objects in the images or photographs such as faces, person identification, or more general objects such as clouds, trees, water, snow, etc. Based on the objects recognized in a photograph, meta-data may be associated with the photograph.

Meta-data associated with the photographs may also include global positioning system (GPS) coordinates that allow embodiments of the invention to determine the location where a particular photograph was taken. Meta-data that is associated with the photographs may also include audio describing the photograph or text meaningful to a particular user such as the name of the person or place in the photographs Meta-data may also include a date and time indicating when each photograph was taken. Another possible meta-data indicator, such as unknown, may help to identify photographs that are blurred or were taken by mistake (e.g., a picture of the carpet), for example. Meta-data for the photographs may be stored in media meta-data and theme database 108.

Media analyzer module 104 may then process the meta-data in database 108 to generate a list of possible meta-data tags. Meta-data tags provide an indication of the frequency and number for each type of meta-data found in database 108. For example, a tag may be people, snow, tree, time, location, similar GPS coordinates, animal, unknown, and so forth. The list of possible meta-data tags may also be stored in database 108.

In embodiments, inference engine module 110 may then process the meta-data tags to create a listing of themes for possible slideshows. It is important to note that the initial listing of themes automatically generated by inference engine module 110 may be customized by the user via feedback while viewing the slideshows (discussed further below).

For example, “nature” may be a possible theme that would include meta-data related to nature such as snow, tree, and so forth. Another example may be “family and friends” that would include meta-data related to people. “Pets” may be a possible theme that would include meta-data related to animals. Embodiments of the invention may determine the place associated with similar GPS coordinate. For example, assume that similar GPS coordinates indicate that the photograph was taken is New York City. Here, a possible theme may be “New York City”. Another possible theme related to the meta-data unknown (blurred or mistake photographs) may help to identify photographs that a viewer may want to delete from storage, for example. The list of themes may also be stored in database 108.

The above example meta-data, meta-data tags and themes are provided for illustration purposes only and are not meant to limit the invention. In fact, the number and types of possible meta-data, meta-data tags and themes contemplated by embodiments of the invention are limitless.

Embodiments of the invention allow for a variety of ways for a user to provide a starting point or indication of the type of slideshow he or she is interested in viewing. This may include, but is not limited to, providing UIM 102 with one or more words such as “the kids” or “nature”, for example. UIM 102 may also display the listing of the themes generated and stored in database 108. Here, the user may use remote control 118 to toggle through the listing of themes and to activate a desired theme. Embodiments of remote control 118 are described in more detail below. The user may also select a particular photograph as a starting point for the slideshow, the meta-data associated with the selected photograph is then matched, within certain rules, to one of the themes available to the user.

Once the user provides an indication of a desired slideshow of photographs, inference engine module 110 automatically selects an array or listing of photographs to include in the slideshow. In embodiments, inference engine module 110 uses information stored in media meta-data and theme database 108, inference engine rule set 112 and user behavior rule set 114 to select the photographs.

Inference engine rule set 112 may be an initial or default set of rules that help to define how to interpret the input provided by the user to select the photographs for the desired slideshow. For example, assume that the user provides the words “the kids” to UIM 102. Here, rule set 112 may associate the words “the kids” to the theme “family and friends” stored in database 108. It is likely that the theme “family and friends” includes many more photographs of people who are not included in “the kids” as interpreted by the user.

Embodiments of the invention provide for user feedback as the slideshow is viewed to help customize the themes stored in database 108. For example, the user can agree and/or disagree with each photograph in the slideshow as he or she is viewing the slideshow. Each time the user provides feedback to UIM 102, inference engine module 110 records the feedback. The feedback may be used to generate one or more user behavior rule sets stored in rule set 114. For example, a new theme “kids” may be created and stored in database 108. This new theme would reflect the feedback from the user in response to his or her request to view a slideshow of “the kids” and feedback provided when he or she viewed the photographs in the slideshow having the initial theme of “Family and friends”. As discussed above, well known object recognition techniques may be used to recognize objects in the photographs such as faces for person identification. Here, object recognition techniques may be applied to the photographs that might be included in the new theme “kids” that will help to identify photographs that should be included in the theme “kids” in the future.

Another example may include a situation where the user has requested a slideshow that relates to “nature”. In the example provided above, one of the themes stored in database 108 is “nature” and example meta-data associated with this theme may include snow, tree, and so forth. But, if the user while viewing the slideshow automatically generated via the theme “nature” has a negative reaction or objects to photographs with the associated meta-data snow, then a user behavior rule may be created and stored in rule set 114 for future reference by inference engine module 110 with the theme “nature” or a related theme. If the user continues to object to photographs associated with meta-data snow for the theme “nature”, then inference engine module 110 may categorically (over time) begin to modify the base rule in inference engine rule set 112 to not include the meta-data snow with the theme “nature” or a related theme.

Another example may involve the GPS coordinate meta-data and GPS coordinate-based rules. Assume that a theme “New York City” includes many photographs with GPS coordinates that indicate the photographs were taken in different areas of New York City. Here, based on user feedback, GPS coordinate-based rules relating to the theme “New York City” may be tightened, for example, to generate a slideshow of photographs taken near Manhattan only.

In embodiments, inference engine module 110 may randomize the generated slideshow of photographs to add surprise into the sequence when it is displayed to the user via slideshow viewer module 116.

In various embodiments, UIM 102 may receive user input via remote control 118. Remote control 118 may allow a user to perform pointing operations similar to a mouse, for example. UIM 102 and remote control 118 allow a user to control a pointer on a display even when situated a relatively far distance from the display, such as normal viewing distance (e.g., 10 feet or more), and without the need for typical wired connections.

Remote control 118 may control, manage or operate the media processing sub-system of UIM 102 by communicating control information using infrared (IR) or radio-frequency (RF) signals. In one embodiment, for example, remote control 118 may include one or more light-emitting diodes (LED) to generate the infrared signals. The carrier frequency and data rate of such infrared signals may vary according to a given implementation. An infrared remote control may typically send the control information in a low-speed burst, typically for distances of approximately 30 feet or more. In another embodiment, for example, remote control 118 may include an RF transceiver. The RF transceiver may match the RF transceiver used by the media processing sub-system. An RF remote control typically has a greater distance than an IR remote control, and may also have the added benefits of greater bandwidth and removing the need for line-of-sight operations. For example, an RF remote control may be used to access devices behind objects such as cabinet doors.

The control information may include one or more IR or RF remote control command codes (“command codes”) corresponding to various operations that the device is capable of performing. The command codes may be assigned to one or more keys or buttons included with the I/O device 120 for remote control 118. I/O device 120 may comprise various hardware or software buttons, switches, controls or toggles to accept user commands. For example, I/O device 120 may include an alphanumeric keypad, arrow buttons, selection buttons, power buttons, mode buttons, selection buttons, menu buttons, and other any means of providing input to UIM 102. There are many different types of coding systems and command codes, and generally different manufacturers may use different command codes for controlling a given device.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

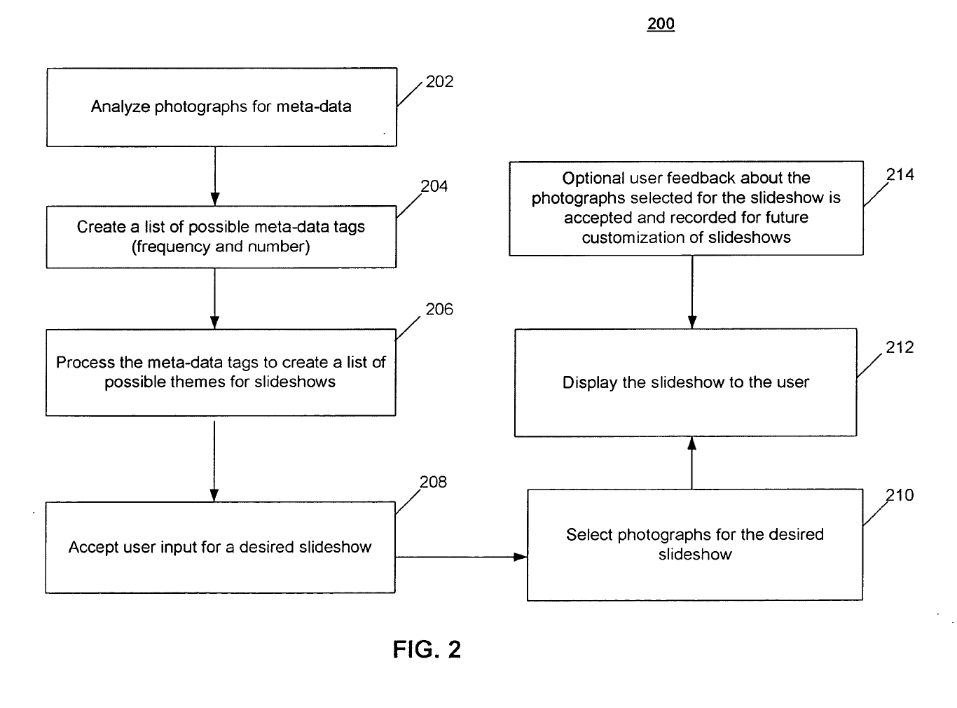

FIG. 2 illustrates one embodiment of a logic flow. FIG. 2 illustrates a logic flow 200. Logic flow 200 may be representative of the operations executed by one or more embodiments described herein, such as UIM 102. Referring to FIG. 2, photographs are analyzed for meta-data (block 202). A list of possible meta-data tags are created based on frequency and number of the meta-data (block 204). The meta-data tags are processed to create a list of possible themes for slideshows (block 206). The meta-data, meta-data tags and list of possible themes may all be stored in media meta-data and theme database 108.

User input is accepted that indicates the starting point for a slideshow that the user wants to view (block 208). UIM 102 automatically generates a slideshow of photographs based on the user input (block 210). In embodiments, inference engine module 110 of UIM 102 uses the user input and information stored in media meta-data and theme database 108, inference engine rule set 112 and user behavior rule set 114 to select the photographs for the slideshow.

The automatically generated slideshow is displayed to the user (block 212). Optional user feedback about the photographs selected for the slideshow is accepted and recorded by UIM 102 for future customization of slideshows (block 214).

As described above, embodiments of the invention are not limited to the use of photographs. In fact, the invention applies to any media content or information including, but are not limited to, alphanumeric text, symbols, images, graphics, audio, video clips, and so forth. For example, a variety of devices now allow a person to record video clips. Such devices may include, but are not limited to, video recorders, digital cameras, cellular phones, and so forth. In embodiments, video clips may be stored in media database 106 or on one or more electronic devices in the digital home network.

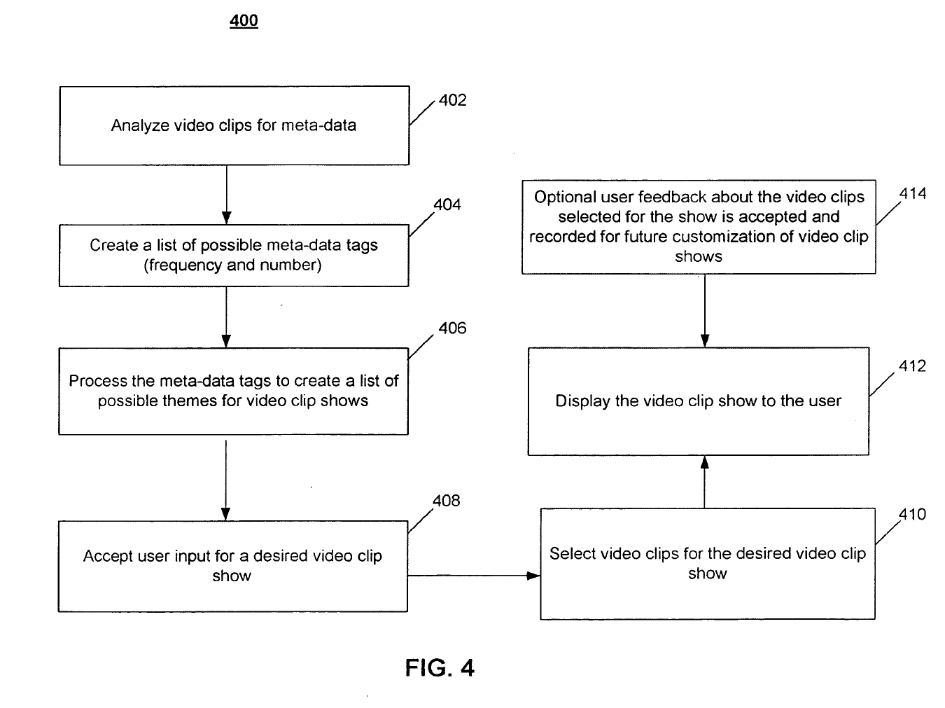

FIG. 4 illustrates one embodiment of a logic flow. FIG. 4 illustrates a logic flow 400. Logic flow 400 may be representative of the operations executed by one or more embodiments described herein, such as UIM 102. Referring to FIG. 4, video clips are analyzed for meta-data (block 402). A list of possible meta-data tags are created based on frequency and number of the meta-data (block 404). The meta-data tags are processed to create a list of possible themes for video clip shows (block 406). The meta-data, meta-data tags and list of possible themes may all be stored in media meta-data and theme database 108.

User input is accepted that indicates the starting point for a video clip show that the user wants to view (block 408). UIM 102 automatically generates a show of video clips based on the user input (block 410). In embodiments, inference engine module 110 of UIM 102 uses the user input and information stored in media meta-data and theme database 108, inference engine rule set 112 and user behavior rule set 114 to select the video clips for the slideshow.

The automatically generated video clip show is displayed to the user (block 412). Optional user feedback about the video clips selected for the slideshow is accepted and recorded by UIM 102 for future customization of video clip shows (block 414).

FIG. 3 illustrates one embodiment of a media processing system in which some embodiments of the invention may operate. FIG. 3 illustrates a block diagram of a media processing system 300. In one embodiment, system 300 may represent a networked digital home environment, although system 300 is not limited in this context.

In one embodiment, for example, media processing system 300 may include multiple nodes. A node may comprise any physical or logical entity for processing and/or communicating, information in the system 300 and may be implemented as hardware, software, or any combination thereof, as desired for a given set of design parameters or performance constraints. Although FIG. 3 is shown with a limited number of nodes in a certain topology, it may be appreciated that system 300 may include more or less nodes in any type of topology as desired for a given implementation. The embodiments are not limited in this context.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a television, a digital television, a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. The embodiments are not limited in this context.

In various embodiments, media processing system 300 may communicate, manage, or process information in accordance with one or more protocols. A protocol may comprise a set of predefined rules or instructions for managing communication among nodes. A protocol may be defined by one or more standards as promulgated by a standards organization, such as, the International Telecommunications Union (ITU), the International Organization for Standardization (ISO), the International Electrotechnical Commission (IEC), the Institute of Electrical and Electronics Engineers (IEEE), the Internet Engineering Task Force (IETF), the Motion Picture Experts Group (MPEG), Joint Photographic Experts Group (JPEG), and so forth. For example, the described embodiments may be arranged to operate in accordance with standards for media processing, such as the National Television Systems Committee (NTSC) standard, the Advanced Television Systems Committee (ATSC) standard, the Phase Alteration by Line (PAL) standard, the MPEG-1 standard, the MPEG-2 standard, the MPEG-4 standard, the Digital Video Broadcasting Terrestrial (DVB-T) broadcasting standard, the DVB Satellite (DVB-S) broadcasting standard, the DVB Cable (DVB-C) broadcasting standard, the Open Cable standard, the Society of Motion Picture and Television Engineers (SMPTE) Video-Codec (VC-1) standard, the ITU/IEC H.263 standard, Video Coding for Low Bitrate Communication, ITU-T Recommendation H.263v3, published November 2000 and/or the ITU/IEC H.264 standard, Video Coding for Very Low Bit Rate Communication, ITU-T Recommendation H.264, published May 2003, and so forth. The embodiments are not limited in this context.

In various embodiments, the nodes of media processing system 300 may be arranged to communicate, manage or process different types of information, such as media information, and control information. Examples of media information may generally include any data or signals representing content meant for a user, such as media content, voice information, video information, audio information, image information, textual information, numerical information, alphanumeric symbols, graphics, and so forth. Control information may refer to any data or signals representing commands, instructions or control words meant for an automated system. For example, control information may be used to route media information through a system, to establish a connection between devices, instruct a node to process the media information in a predetermined manner, monitor or communicate status, perform synchronization, and so forth. The embodiments are not limited in this context.

In various embodiments, media processing system 300 may be implemented as a wired communication system, a wireless communication system, or a combination of both. Although media processing system 300 may be illustrated using a particular communications media by way of example, it may be appreciated that the principles and techniques discussed herein may be implemented using any type of communication media and accompanying technology. The embodiments are not limited in this context.

In various embodiments, media processing system 300 may include one or more media source nodes 302-1-n. Media source nodes 302-1-n may comprise any media source capable of sourcing or delivering media information and/or control information to media processing node 306. More particularly, media source nodes 302-1-n may comprise any media source capable of sourcing or delivering digital images, digital audio and/or video (AV) signals to media processing node 306. Examples of media source nodes 302-1-n may include any hardware or software element capable of storing and/or delivering media information, such as a DVD device, a VHS device, a digital VHS device, a personal video recorder, a computer, a gaming console, a Compact Disc (CD) player, computer-readable or machine-readable memory, a digital camera, camcorder, video surveillance system, teleconferencing system, telephone system, medical and measuring instruments, scanner system, copier system, television system, digital television system, set top boxes, personal video records, server systems, computer systems, personal computer systems, digital audio devices (e.g., MP3 players), and so forth. Other examples of media source nodes 302-1-n may include media distribution systems to provide broadcast or streaming analog or digital AV signals to media processing node 306. Examples of media distribution systems may include, for example, Over The Air (OTA) broadcast systems, terrestrial cable systems (CATV), satellite broadcast systems, and so forth. It is worthy to note that media source nodes 302-1-n may be internal or external to media processing node 306, depending upon a given implementation. The embodiments are not limited in this context.

In various embodiments, media processing system 300 may comprise a media processing node 306 to connect to media source nodes 302-1-n over one or more communications media 304-1-m. Media processing node 306 may comprise any node that is arranged to process media information received from media source nodes 302-1-n.

In various embodiments, media processing node 306 may include a media processing sub-system 308. Media processing sub-system 308 may comprise a processor, memory, and application hardware and/or software arranged to process media information received from media source nodes 302-1-n. For example, media processing sub-system 308 may be arranged to perform various media operations and user interface operations as described in more detail below. Media processing sub-system 308 may output the processed media information to a display 310. The embodiments are not limited in this context.

To facilitate operations, media processing sub-system 308 may include a user interface module (such as UIM 102 of FIG. 1) to provide the functionality of UIM 102 as described herein. The embodiments are not limited in this context.

In various embodiments, the user interface module may allow a user to control certain operations of media processing node 306, such as various system programs or application programs. For example, assume media processing, node 306 comprises a television that has access to user menu options provided via media source node 302-1-n. These menu options may be provided for viewing or listening to media content reproduced or provided by media source node 302-1-n. The user interface module may display user options to a viewer on display 310 in the form of a graphic user interface (GUI), for example. In such cases, a remote control (such as remote control 118 of FIG. 1) is typically used to navigate through such basic options.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

Some embodiments may be implemented, for example, using any computer-readable media, machine-readable media, or article capable of storing software. The media or article may include any suitable type of memory unit, memory device, memory article, memory medium, storage device, storage article, storage medium and/or storage unit, such as any of the examples described with reference to memory. The media or article may comprise memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), subscriber identify module, tape, cassette, or the like. The instructions may include any suitable type of code, such as source code, object code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, JAVA, ActiveX, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. A method, comprising:
determining meta-data associated with a plurality of photographs;
determining one or more tags associated with the meta-data, wherein the one or more tags indicate a frequency and a number of the meta-data;
accepting a starting point for a presentation of photographs from a user; and
based on the starting point, the one or more tags and a rule set, automatically generating a list of photographs from the plurality of photographs to be included in the presentation.

2. The method of claim 1, further comprising:
displaying the list of photographs; and
accepting feedback from the user about one or more photographs in the list of photographs.

3. The method of claim 2, further comprising:
customizing the rule set based on the feedback from the user.

4. The method of claim 2, further comprising:
randomizing the order of the list of photographs prior to displaying.

5. The method of claim 1, wherein the presentation is a slideshow.

6. The method of claim 1, further comprising:
generating one or more themes for the plurality of photographs based on the tags.

7. The method of claim 6, further comprising:
displaying the one or more themes to the user; and
allowing the user to select one of the one or more themes as the starting point.

8. The method of claim 6, further comprising:
allowing the user to input a representative photograph; and
based on the representative photograph, determining a theme from the one or more themes as the starting point.

9. An apparatus, comprising:
a user interface module adapted to:
determine meta-data associated with a plurality of photographs,
determine one or more tags associated with the meta-data, wherein the one or more tags indicate a frequency and a number of the meta-data,
accept a starting point for a presentation of photographs from a user, and
based on the starting point, the one or more tags and a rule set, automatically generate a list of photographs from the plurality of photographs to be included in the presentation.

10. The apparatus of claim 9, wherein the user interface module is further adapted to:
display the list of photographs; and
accept feedback from the user about one or more photographs in the list of photographs.

11. The apparatus of claim 10, wherein the user interface module is further adapted to:
customize the rule set based on the feedback from the user.

12. The apparatus of claim 10, wherein the user interface module is further adapted to: randomize the order of the list of photographs prior to displaying.

13. The apparatus of claim 9, wherein the presentation is a slideshow.

14. The apparatus of claim 9, wherein the user interface module is further adapted to:
generate one or more themes for the plurality of photographs based on the tags.

15. The apparatus of claim 14, wherein the user interface module is further adapted to:
display the one or more themes to the user; and
allow the user to select one of the one or more themes as the starting point.

16. The apparatus of claim 14, wherein the user interface is further adapted to:
allow the user to input a representative photograph; and
based on the representative photograph, determine a theme from the one or more themes as the starting point.

17. A machine-readable storage medium containing instructions which, when executed by a processing system, cause the processing system to perform a method, the method comprising:
determining meta-data associated with a plurality of photographs;
determining one or more tags associated with the meta-data, wherein the one or more tags indicate a frequency and a number of the meta-data;
accepting a starting point for a presentation of photographs from a user; and
based on the starting point, the one or more tags and a rule set, automatically generating a list of photographs from the plurality of photographs to be included in the presentation.

18. The machine-readable storage medium of claim 17, further comprising:
displaying the list of photographs; and
accepting feedback from the user about one or more photographs in the list of photographs.

19. The machine-readable storage medium of claim 18, further comprising:
customizing the rule set based on the feedback from the user.

20. The machine-readable storage medium of claim 18, further comprising:
randomizing the order of the list of photographs prior to displaying.

21. The machine-readable storage medium of claim 17, wherein the presentation is a slideshow.

22. The machine-readable storage medium of claim 17, further comprising:
generating one or more themes for the plurality of photographs based on the tags.

23. The machine-readable storage medium of claim 22, further comprising:
displaying the one or more themes to the user; and
allowing the user to select one of the one or more themes as the starting point.

24. The machine-readable storage medium of claim 22, further comprising:
allowing the user to input a representative photograph; and
based on the representative photograph, determining a theme from the one or more themes as the starting point.

25. A method, comprising:
determining meta-data associated with a plurality of video clips;
determining one or more tags associated with the meta-data, wherein the one or more tags indicate a frequency and a number of the meta-data;
accepting a starting point for a presentation of video clips from a user; and
based on the starting point, the one or more tags and a rule set, automatically generating a list of video clips from the plurality of video clips to be included in the presentation.
